(19) United States
(12) Patent Application Publication
(10) Pub. No.: US 2006/0273123 A1
(43) Pub. Date: Dec. 7, 2006

(54) Rack tower assemblies and rack systems

(76) Inventor: Joseph J. Settelmayer, Fieldbrook, CA (US)

Correspondence Address: KOLISCH HARTWELL, P.C., 200 PACIFIC BUILDING, 520 SW YAMHILL STREET, PORTLAND, OR, 97204, US

(21) Appl. No.: 11/237,616

(22) Filed: Sep. 27, 2005

Related U.S. Application Data
(60) Provisional application No. 60/613,643, filed on Sep. 27, 2004.

(51) Int. Cl. B60R 9/00

(52) U.S. Cl. 224/325

(57) ABSTRACT

Rack tower assemblies and rack systems having rack tower assemblies for vehicles are disclosed. The rack tower assemblies are for detachably mounting a transversely extending crossbar to a roof of a vehicle. The rack systems include a crossbar- and a pair of rack tower assemblies.

### CROSS-REFERENCE TO RELATED APPLICATIONS

This application claims priority under 35 U.S.C. §119(e) to U.S. Provisional Patent Application Ser. No. 60/613,643 entitled “Rack Tower with Interchangeable Components,” filed Sep. 27, 2004. The complete disclosure of that application is hereby incorporated by reference for all purposes.

### BACKGROUND

Top-mounted vehicle rack systems provide a versatile platform for transporting bicycles, skis, snowboards, boats, cargo boxes, gear racks, and/or other items. Such rack systems may include crossbars that extend side-to-side across a top or roof of a vehicle. The crossbars typically are supported on each side of the vehicle's roof by a tower, where the distance between transversely extending crossbars depends on factors such as the shape and size of the vehicle's roof.

The towers supporting the rack crossbars are securely fastened to the vehicle in some manner, to prevent the rack from slipping during use. In the case of vehicles that do not have pre-installed rails (often referred to as a “factory rack”), the fastening mechanism may include clips that attach directly to the underside of the vehicle roof, where a window of the car meets the roof. The clips may be customized to fit a particular vehicle while still allowing the doors of the vehicle to open and close normally with the rack installed.

In the case of vehicles that do have a preinstalled factory rack, the rack towers may be attached directly to the rails of the factory rack, avoiding any need to insert clips under the vehicle roof. Attachment of rack towers to a factory rack may be accomplished using clips or hooks that attach to the outer edge or underside of the rails, in a manner similar to attaching the towers directly to the vehicle roof.

Vehicle factory racks are manufactured in a wide variety of shapes and styles, and in some cases the rails of a factory rack may be provided with a groove, notch, and/or recess specifically designed for allowing attachment of a rack. The groove may be provided either on the inboard or the outboard side of the rail, and it may have a vehicle-specific shape or profile. Therefore, attachment of a tower to a grooved factory rack may require a uniquely shaped clip mechanism and/or tower body.

Due to the possible need for specially configured clips and/or towers, existing rack systems may not be configured to be mounted on a vehicle equipped with a particular factory rack. A rack manufacturer may find undesirable the need to design and offer for sale separate tower designs for every different make or model of car that uses a different factory rail configuration. Furthermore, a user may wish to move a rack from one vehicle equipped with a factory rack to another, where the rails on the two vehicles have differently shaped surfaces and attachment grooves.

### SUMMARY

The invention provides rack systems and devices for carrying cargo on the roof of a vehicle. For example, towers for supporting crossbars may be configured to clamp or grip factory installed longitudinal rails.

### BRIEF DESCRIPTION OF THE DRAWINGS

FIG. 1 is an isometric view of a rack tower assembly.

FIG. 1A is an isometric view of the rack tower assembly of FIG. 1 combined with a crossbar for mounting on a vehicle roof rail.

FIG. 2 is a side view of the rack tower assembly of FIG. 1A installed on a roof rail of a vehicle with the roof rail shown in cross-section.

FIG. 3 is an isometric view of the rack tower assembly of FIG. 1A showing a securing device.

FIG. 4 is a bottom view of the rack tower assembly of FIG. 1.

FIG. 5 is an exploded view of the rack tower assembly of FIG. 1.

### DETAILED DESCRIPTION

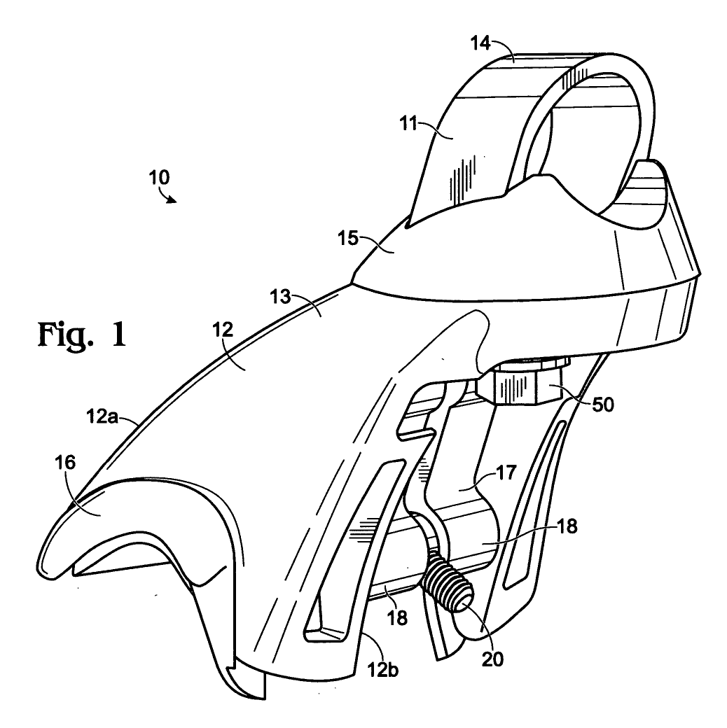

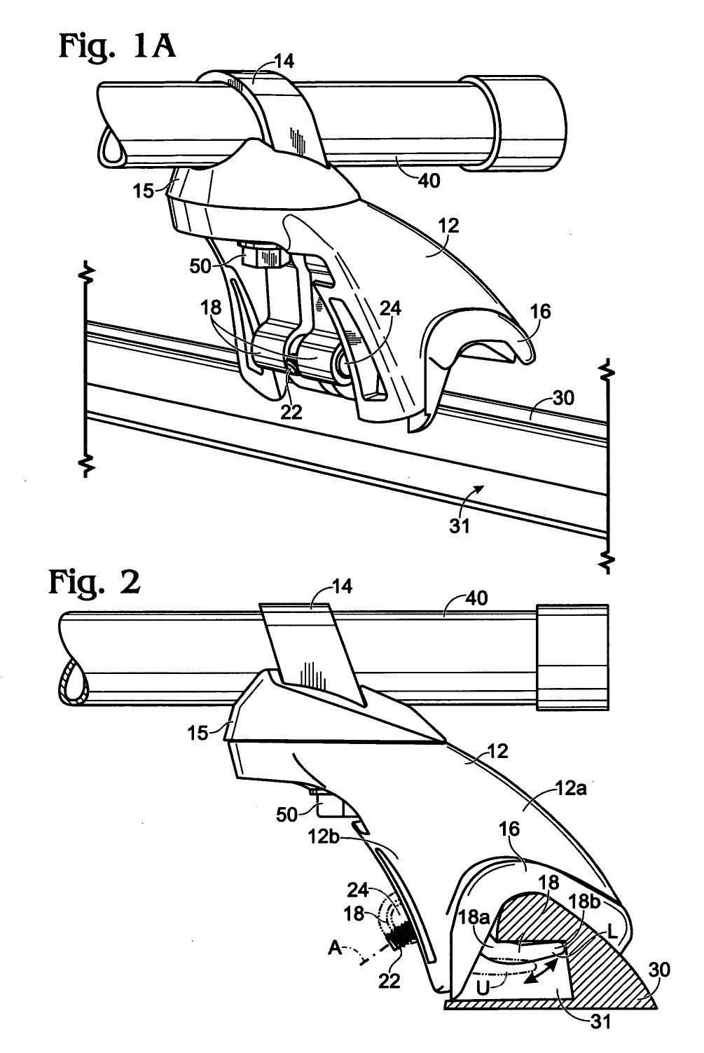

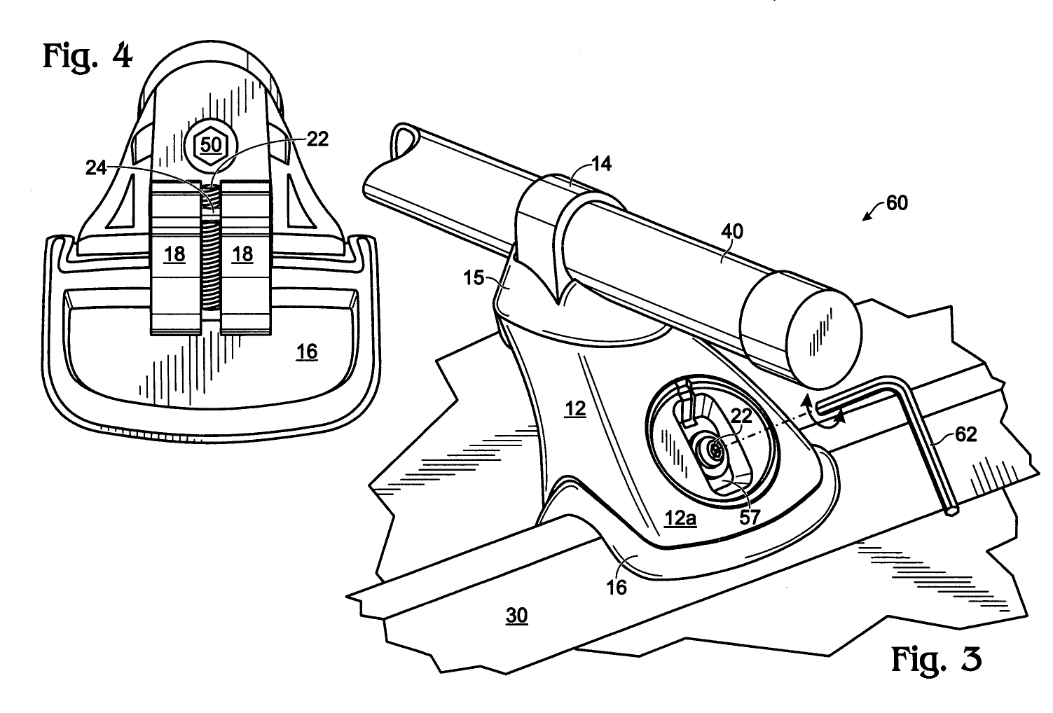

25 FIGS. 1-5 depict some embodiments of a rack tower assembly 10. Rack tower assembly 10 may include any suitable structure configured to detachably mount and/or secure a crossbar 40 to a roof of a vehicle, such as a vehicle with roof rail 30. For example, rack tower assembly 10 may include a support assembly 11, an interconnect assembly 13, and a mount assembly 17.

Support assembly 11 may include any suitable structure configured to support and/or secure crossbar 40. For example, the support assembly may include a crossbar clamp 14, a clamp base 15, and a fastening member 50, as shown in FIGS. 1-2. Crossbar clamp 14 may include any suitable structure configured to support and/or secure crossbar 40. Clamp base 15 and fastening member 50 may include any suitable structure configured to attach and/or secure crossbar clamp 14 to interconnect assembly 13. For example, clamp base 15 may be configured to receive fastening member 50 (such as a bolt) to secure crossbar clamp 14 to interconnect assembly 13.

Although crossbar clamp 14 is shown to include a ring structure or shear block configured to be slid through the crossbar, any suitable structure may be used configured to support and/or secure the crossbar. For example, the crossbar clamp may be non-circular to support non-circular crossbars. Additionally, or alternatively, the crossbar clamp may be hinged in any suitable way to permit mounting to the crossbar along a direction perpendicular to the crossbar or any suitable direction.

Additionally, although clamp base 15 and fastening member 50 are shown to include specific structure, any suitable structure may be used configured to secure crossbar clamp 14 to interconnect assembly 13. For example, fastening members may alternatively, or additionally, include one or more clips, screws, etc. Moreover, although support assembly 11 is shown to include the crossbar clamp, clamp base, and fastening member, the support assembly may include any suitable structure configured to support and/or secure crossbar 40.

Interconnect assembly 13 may include any suitable structure configured to connect or operatively connect support assembly 11 to mount assembly 17. Additionally, or alternatively, the interconnect assembly may include any suitable structure configured to at least partially contain the mount assembly and/or to assist the mount assembly in securing the crossbar to the roof of the vehicle. For example, the interconnect assembly may include a main or tower body 12, as shown in FIGS. 1-2. The tower body may have any suitable shape, including shapes that provide low profile and/or sleek appearances. Additionally, the tower body may have an outer or outboard surface 12a and an inner or inboard surface 12b. The outer surface may be located opposite the inner surface, while the inner surface faces towards a center of the vehicle when the tower assembly is mounted on the roof rail, as shown in FIG. 2.

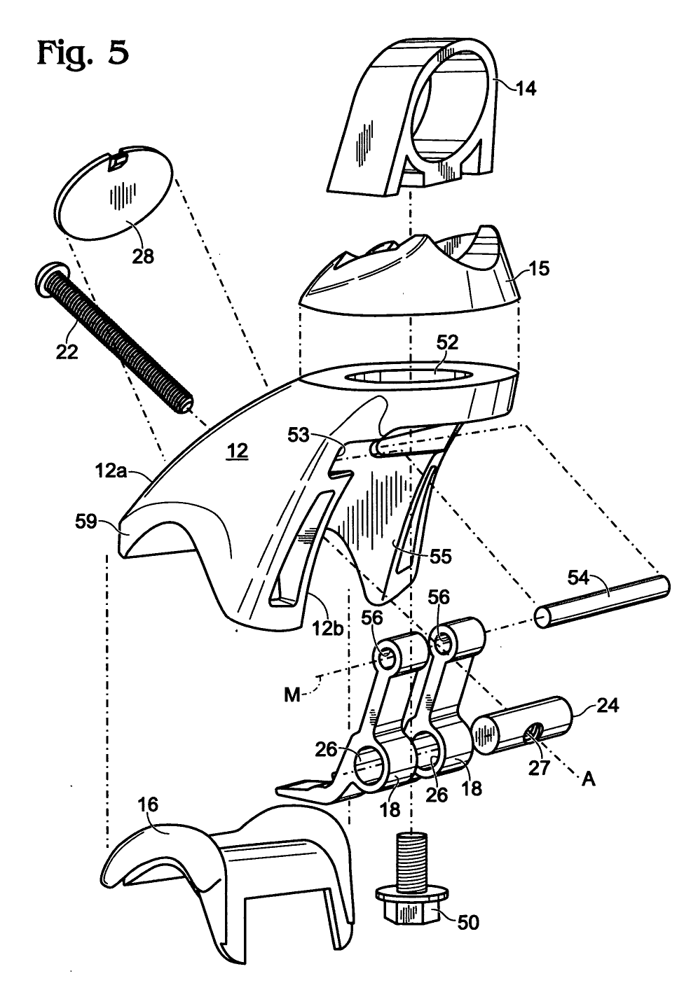

Tower body 12 may include a clamp aperture 52, a hinge recess 53, a mount assembly hollow 55, an adjustment aperture 57, and a base 59, as shown in FIGS. 3 and 5. The clamp aperture may be configured to receive clamp base 15 and fastening member 50 to secure the crossbar clamp to the tower body. Hinge recess 53, mount assembly hollow 55, and adjustment aperture 57 may be configured to receive and/or secure one or more portions of the mount assembly, as further discussed below. Additionally, hinge recess 53 may be configured such that access to the recess is restricted when fastening member is in clamp aperture 52. Moreover, adjustment aperture 57 may be configured such that the one or more portions of the mount assembly may be accessed from the outer surface of the tower body.

Base 59 may be configured to conform to roof rail 30. The base also may, in conjunction with the mount assembly, be configured to secure the tower assembly to the roof rail (as further discussed below), thereby securing the crossbar to the roof of the vehicle.

Although base 59 is shown to include a specific shape and/or structure, the base may include any suitable shape and/or structure configured to conform to roof rail 30 and/or secure the tower assembly to the roof rail. For example, base 59 may be configured to be adjustable to conform to different types of roof rails. Additionally, although the apertures, recess, and hollow are shown to be in specific locations of the tower body, those apertures, recess, and hollow may be in any suitable locations. Moreover, although the tower body is shown to include specific structure, the tower body may include any suitable structure configured to secure the crossbar clamp to the tower body, to at least partially contain the mount assembly, and/or to assist the mount assembly in securing the crossbar to the roof of the vehicle.

Interconnect assembly 13 also may include a mounting pad 16, which may include any suitable structure configured to be attached to base 59 of tower body 12 and/or to protect the vehicle and/or tower body from scratching and/or other damage. Although mounting pad 16 is shown to include a specific shape and/or structure, the mounting pad may include any suitable shape and/or structure configured to be attached to the base of the tower body and/or to protect the vehicle and/or tower body from scratching and/or other damage.

Additionally, interconnect assembly 13 may include a cover 28, which may include any suitable structure configured to cover adjustment aperture 57 of the tower body. The cover may be used to protect one or more components of the mount assembly from the elements, such as rain or snow. Although cover 28 is shown to include a specific shape and/or structure, any suitable shape and/or structure may be used configured to cover adjustment aperture 57 and/or to protect one or more components of the mount assembly.

Although interconnect structure 13 is shown to include tower body 12, mounting pad 16, and cover 28, the interconnect structure may include any suitable structure configured to connect or operatively connect the support assembly to the mount assembly, to at least partially contain the mount assembly, and/or assist the mount assembly in securing the crossbar to the roof of the vehicle.

Mount assembly 17 may include any suitable structure configured to at least partially engage one or more portions of roof rail 30, such as recess 31, to secure the crossbar to the roof rail. For example, mount assembly 17 may include at least one mounting element 18, a mounting hinge 54, and an adjustment mechanism 20, as shown in FIGS. 1 and 5.

Mounting element 18 may include any suitable structure configured to at least partially engage one or more portions of the roof rail. For example, the mounting element may include at least one mounting clip, at least one mounting hook, and/or at least one mounting claw. Additionally, the mounting element may be configured to move among a plurality of positions. For example, as shown in FIG. 2, mounting element 18 may be configured to move between a first or locking position L in which the mounting element engages the recess to secure the crossbar to the roof rail, and a second or unlocking position U in which the mounting element is spaced from the recess to allow movement of the crossbar relative to the roof rail. Although first and second mounting elements are shown in FIGS. 1-5, any suitable number of mounting elements may be used.

Mounting element 18 may move among the plurality of positions in any suitable way(s). For example, the mounting element may be pivotally connected to the tower body via a mounting hinge 54, such that the mounting element pivots among the plurality of positions about any suitable axis or axes, such as mounting axis M that is at least substantially perpendicular to the crossbar.

Although mounting element is shown to be configured to pivot about mounting axis M, the mounting element may additionally, or alternatively, be configured to pivot any suitable axis or axes. Additionally, although mounting element 18 is shown to be configured to pivot among the plurality of positions, the mounting element may alternatively, or additionally, be configured to slide, rotate, and/or move in any other suitable way among the plurality of positions.

The mounting element may include any suitable number of apertures or openings to allow the mounting element to be secured to the tower body, to allow a mounting element to be attached to one or more other mounting elements, and/or to allow the mounting element to be adjusted by adjustment mechanism 20. For example, mounting element 18 may include support aperture 24 and hinge aperture 56, as shown in FIG. 5. Support aperture 26 may include any suitable structure configured to receive a support element 24, as further discussed below. Hinge aperture 56 may include any suitable structure configured to receive mounting hinge 54 Mounting element 18 may have any suitable shape configured to engage the recess of roof rail 30. For example, the mounting element may include a first portion 18a configured to engage the recess and to be at least substantially parallel to the crossbar when the mounting element is in the locking position, as shown in FIG. 2. Additionally, or alternatively, the mounting element may include a second portion configured to engage the recess and to curve upward when the mounting element is in the locking position.

Although mounting element 18 is shown to include the first and second portions, the mounting element may include only the first or only the second portion. Additionally, although mounting element 18 is shown to curve upward when the mounting element is in the locking position, the mounting element may be shaped in any suitable way configured to engage the recess of the roof rail to secure the crossbar to the roof rail.

The mounting element may be any suitable size configured to engage the recess of the roof rail. For example, mounting element 18 may extend into at least a substantial portion of the recess, as shown in FIG. 2. Although mounting element 18 is shown to extend into at least a substantial portion of the recess, the mounting element may extend into any suitable portion of the recess.

Mounting element 18 may be located in any suitable area in the tower body. For example, mounting element 18 may be located in hollow 55. Although the mounting element is shown to be configured to move between the first and second positions, the mounting element may additionally, or alternatively, be configured to move among any suitable position(s). For example, the mounting element may be configured to move to an intermediate position in which the mounting element engages the recess while allowing a user to slide the tower assembly along the roof rail and/or allowing a user to slide the crossbar in the crossbar clamp. Additionally, although mounting element 18 is shown to be at least partially contained within hollow 55 of tower body 12, the mounting element may be located at any suitable location internal and/or external the tower body.

Mounting hinge 54 may include any suitable structure configured to secure mounting element 18 to tower body 12 and/or to allow mounting element 18 to move among the plurality of positions. The mounting hinge may be located in any suitable location of the tower body. For example, mounting hinge 54 may be located in hinge recess 53. The mounting hinge may be retained within the hinge recess in any suitable way. For example, as discussed above, fastening member 50 may block access to hinge recess 53, such that mounting hinge is retained in the hinge recess, as shown in FIG. 1.

Adjustment mechanism 20 may include any suitable structure configured to move, such as pivot, mounting element 18 among the plurality of positions. For example, the adjustment mechanism may include support element 24 and adjustment element 22, as shown in FIG. 5.

Support element 24 may include any suitable structure configured to secure two or more mounting elements together, which may allow those mounting elements to move among the plurality of positions together. The support element may be configured to be received in support aperture 26 of the mounting element. The support element may include an adjustment aperture 27, which may include any suitable structure configured to receive adjustment element 22. Although support element 24 is shown to include a support bar, the support element may include any suitable structure configured to secure two or more mounting elements together, such as securing first and second mounting elements together.

Adjustment element 22 may include any suitable structure configured to selectively adjust, move, and/or pivot the mounting element among the plurality of positions, such as between locking position L and unlocking position U. For example, the adjustment element may include a bolt 22 configured to be received in adjustment aperture 57 of tower body 12 and adjustment aperture 27 of support element 24, and to move along an adjustment axis A that is at least substantially perpendicular to the outer surface of the tower body.

As discussed above, the bolt may be configured to be accessed from the outer surface of the tower body to allow for easy installation and/or removal of the tower assembly, as shown in FIG. 3. For example, a user may use tool 62 to move adjustment element 22, thereby moving mounting element 18 among the plurality of positions. As the user moves tool 62 clockwise (or counter-clockwise), the mounting element may move between the unlocking position to the locking position. In the locking position, the mounting element may clamp on roof rail 30 against the base of the tower body to secure the crossbar to tower assembly and/or the tower assembly to the roof rail, thereby securing the crossbar to the roof of the vehicle.

Although bolt 22 is shown to move along adjustment axis A, the bolt may move along any suitable axis or axes. Additionally, although the adjustment element is shown to include bolt 22, the adjustment element may include any suitable structure configured to selectively adjust, move, and/or pivot the mounting element among the plurality of positions. Moreover, although adjustment element 22 is shown to be adjustable via a specific tool, the adjustment element may be configured to be adjustable via any suitable tools and/or by hand.

Tower assembly 10 may be provided in a kit that includes two or more different types of crossbar clamps, mounting elements, and/or mounting pads to allow a user to use the tower assembly on vehicles with different roof rails.

The present disclosure also includes a rack system 60 for a roof of a vehicle, such as a roof including a center and a pair of longitudinally extending roof rails 30 with each of those rails including a recess 31, as shown in FIG. 3. The rack system may include crossbar 40, which may be sized to extend across the roof of the vehicle. Rack system 60 also may include a pair of tower assemblies, although only one of those assemblies is shown in FIG. 3. The tower assemblies may include any suitable structure configured to secure crossbar 40 to roof rail 30. For example, each of the tower assemblies may include one or more components of the tower assemblies discussed above. Additionally, or alternatively, the rack system may consist of two or more crossbars with at least one tower assembly associated with each crossbar.

Although rack tower assemblies and rack systems and features of those assemblies and systems have been shown and described with reference to the foregoing operational principles and preferred embodiments, those skilled in the art will find apparent that various changes in form and detail may be made without departing from the spirit and scope of the claims. The present disclosure is intended to embrace all such alternatives, modifications, and variances that fall within the scope of the appended claims.

I claim:

1. A tower assembly for detachably mounting a transversely extending crossbar to a roof of a vehicle, the roof of the vehicle including a center and a longitudinally extending rail having a recess, comprising:
a tower body including an outer surface and an inner surface, the outer surface located opposite the inner surface, and the inner surface facing towards the center of the roof of the vehicle when the tower assembly is mounted on the rail;
a crossbar clamp attached to the tower body and configured to support the crossbar;
at least one mounting clip configured to move between a first position in which the mounting clip engages the recess to secure the crossbar to the roof rail, and a second position in which the mounting clip is spaced from the recess to allow movement of the crossbar relative to the roof rail; and
an adjustment mechanism configured to move the mounting clip between first and second positions, wherein the adjustment mechanism is accessible from the outer surface of the tower body.

2. The tower assembly of claim 1, wherein the mounting clip includes at least one mounting hook.

3. The tower assembly of claim 2, wherein the mounting hook includes a first portion configured to engage the recess and to be at least substantially parallel to the crossbar when the mounting clip is in the first position.

4. The tower assembly of claim 3, wherein the mounting hook includes a second portion configured to engage the recess and to curve upward when the mounting clip is in the first position.

5. The tower assembly of claim 1, wherein the mounting clip is sized to extend into at least a substantial portion of the recess.

6. The tower assembly of claim 1, wherein the adjustment mechanism includes a bolt accessible from the outer surface of the tower body and configured to move the mounting clip among the plurality of positions.

7. The tower assembly of claim 6, wherein the bolt is configured to pivot the mounting clip among the plurality of positions.

8. The tower assembly of claim 7, wherein the mounting clip is configured to pivot about a mounting axis that is at least substantially perpendicular to the crossbar.

9. The tower assembly of claim 6, wherein the bolt is configured to move along an adjustment axis that is at least substantially perpendicular to the outer surface of the tower body.

10. The tower assembly of claim 6, wherein the at least one mounting clip includes a first mounting clip and a second mounting clip, and the bolt is configured to move the first and second mounting clips among the plurality of positions.

11. The tower assembly of claim 10, wherein the bolt is configured to pivot the first and second mounting clips among the plurality of positions.

12. A tower assembly for detachably mounting a transversely extending crossbar to a roof of a vehicle, the roof of the vehicle including a longitudinally extending rail having a recess, comprising:
a tower body including an outer surface and an inner surface, the outer surface located opposite the inner surface, and the inner surface facing towards a center of the roof of the vehicle when the tower assembly is mounted on the rail;
a crossbar clamp attached to the tower body and configured to support the crossbar;
at least a pair of mounting claws configured to pivot between a first position in which the mounting claws engage the recess to secure the crossbar to the roof rail, and a second position in which the mounting claws are spaced from the recess to allow movement of the crossbar relative to the roof rail; and
an adjustment mechanism configured to move the mounting claws between the first and second positions, the adjustment mechanism being accessible from the outer surface of the tower body.

13. A tower assembly for detachably mounting a transversely extending crossbar to a roof of a vehicle, the roof of the vehicle including a longitudinally extending rail having a recess, comprising:
a tower body including an outer surface and an inner surface, the outer surface located opposite the inner surface, and the inner surface facing towards a center of the roof of the vehicle when the tower assembly is mounted on the rail;
a crossbar clamp attached to the tower body and configured to support the crossbar; and
at least a pair of mounting claws configured to pivot between a first position in which the curved mounting claws engage the recess to secure the crossbar to the roof rail, and a second position in which the mounting claws are spaced from the recess to allow movement of the crossbar relative to the roof rail.

14. A rack system for a roof of a vehicle, the roof of the vehicle including a center and a pair of longitudinally extending rails, each of the rails including a recess, comprising:
a crossbar sized to extend across the roof of the vehicle; and
a pair of tower assemblies configured to secure the crossbar to the pair of rails, each tower assembly including:
a tower body including an outer surface and an inner surface, the outer surface located opposite the inner surface, and the inner surface facing towards the center of the roof of the vehicle when the tower assembly is mounted on the rail;
a crossbar clamp attached to the tower body and configured to support the crossbar;
at least one mounting hook configured to pivot between a first position in which the mounting hook engages the recess to secure the crossbar to the roof rail, and a second position in which the mounting hook is spaced from the recess to allow movement of the crossbar relative to the roof rail; and
an adjustment mechanism configured to pivot the mounting hook between the first and second positions, wherein the adjustment mechanism is accessible from the outer surface of the tower body.

15. The tower assembly of claim 14, wherein the mounting hook includes a first portion configured to engage the recess and to be at least substantially parallel to the crossbar when the mounting hook is in the first position.

16. The tower assembly of claim 15, wherein the mounting hook includes a second portion configured to engage the recess and to curve upward when the mounting hook is in the first position.

17. The tower assembly of claim 14, wherein the adjustment mechanism includes a bolt accessible from the outer surface of the tower body and configured to pivot the mounting hook between the first and second positions.

18. The tower assembly of claim 17, wherein the bolt is configured to move along an adjustment axis that is at least substantially perpendicular to the outer surface of the tower body.

19. The tower assembly of claim 14, wherein the mounting hook pivots about an axis that is at least substantially perpendicular to the crossbar.

20. The tower assembly of claim 14, wherein the at least one mounting hook includes a first mounting hook and a second mounting hook, and the bolt is configured to pivot the first and second mounting hooks between the first and second positions.
